(19) United States
(12) Patent Application Publication
(10) Pub. No.: US 2024/0302121 A1
(43) Pub. Date: Sep. 12, 2024

(54) RFID-BASED BUILDING RESPONSE TO FIREARM PRESENCE

(71) Applicant: Vigilance Safety, Plymouth, MN (US)

(72) Inventors: Neev Moshe Zeroni, Plymouth, MN (US); Alexander Paul Freeman, Maple Grove, MN (US); Jenny Rachel Zeroni, Plymouth, MN (US); Mike Siegler, St Louis Park, MN (US); Anuj Kakkad, Plymouth, MN (US); Carlee Grace Freeman, Maple Grove, MN (US); Jacob Dane Hoversten, Medina, MN (US); Rushil Mohan Khadilkar, Plymouth, MN (US); May Renee Zeroni, Plymouth, MN (US); Tina Hoversten, Medina, MN (US)

(21) Appl. No.: 18/597,416

(22) Filed: Mar. 6, 2024

Related U.S. Application Data
(60) Provisional application No. 63/488,586, filed on Mar. 6, 2023.

(51) Int. Cl. F41A 17/06; F41H 11/00; G05B 15/02

(52) U.S. Cl. CPC F41A 17/063; F41H 11/00; G05B 15/02

(57) ABSTRACT

The disclosure is directed to a system comprising one or more radio-frequency identification (RFID) sensors and one or more processors configured. The system controls the one or more RFID sensors to emit one or more electromagnetic interrogation pulses, the one or more RFID sensors being installed on or around a building. The system receives, via the one or more RFID sensors, a data tag including an identification number from an RFID tag attached to a firearm. The system determines, based at least in part on the identification number, to perform a responsive action on the building. In response to determining to perform responsive action on the building, the system controls one or more of one or more reactive devices to perform the responsive action on the building.

### RELATED APPLICATIONS

This application claims the benefit of U.S. Provisional Application No. 63/488,586, filed Mar. 6, 2023, the entire contents of which are incorporated herein by reference.

### TECHNICAL FIELD

The disclosure relates to building alarms and lockdown systems.

### BACKGROUND OF THE INVENTION

Recently, the American Public Health Association has named gun violence as a public health issue. Gun violence is a leading cause of premature death in the United States, as guns kill more than 38,000 people and cause nearly 85,000 injuries each year. The desire to design systems and legislation to hinder or prevent gun violence in the United States is seemingly at odds with the Second Amendment of the United States Constitution, meaning that efforts in this area are highly scrutinized and must consider multiple viewpoints to gain acceptance.

### SUMMARY OF THE INVENTION

In general, the disclosure describes a system where radio-frequency identification (RFID) tags are installed on the body of a firearm. RFID sensors are installed in, on, or around a building, such as a school or an office building. The RFID sensors, when active, will scan for the presence of any RFID tags in the vicinity of the building (e.g., 25 feet, 50 feet, 100 feet, 500 feet, etc.). When a firearm including the RFID tag is brought into the vicinity of the building, the RFID tag sends a data packet including an identification number to the RFID sensor. A computer system, either local or remote, will read the identification number and determine whether to initiate responsive actions on the building. For instance, if the identification number is registered as being a police officer or some other trusted gun owner, then the computer system may not initiate such responsive actions. However, if the identification number is not included in such a list, or if the identification number is associated with a list of firearms tagged explicitly as dangerous, then the computer system may control one or more reactive devices to initiate one or more responsive actions, such as sounding an alarm, flashing lights, changing light color, locking doors and windows into the building, contacting emergency services, or a combination of any number of actions.

This system provides a number of advantages over current safety measures. For instance, rather than attempting to alter the functioning of the gun itself, the system described herein only alters characteristics of the building nearby the firearm. This ensures that no devices described herein would violate, or be perceived to violate, Second Amendment rights for any individual who owns a firearm where this RFID tag is installed. Additionally, RFID tags typically only transmit sequences of numbers or some other type of basic information as the transmitted data packet. In this way, no personally identifiable information would be known about the actual user of the firearm, ensuring privacy rights and eliminating the ability to gather information about a particular person against that person's will. Furthermore, by controlling responsive actions for a building in and of itself, lockdown procedures and the contacting of emergency services can see a drastic increase in efficiency, thereby providing more protection to everyone in and around the building.

In one example, the disclosure is directed to a method including controlling, by one or more processors, one or more radio-frequency identification (RFID) sensors to emit one or more electromagnetic interrogation pulses, the one or more RFID sensors being installed on or around a building. The method further includes receiving, by the one or more processors via the one or more RFID sensors, a data tag including an identification number from an RFID tag attached to a firearm. The method also includes determining, by the one or more processors and based at least in part on the identification number, to perform a responsive action on the building. The method further includes, in response to determining to perform responsive action on the building, controlling, by the one or more processors, one or more of one or more reactive devices to perform the responsive action on the building.

In another example, the disclosure is directed to a system including one or more radio-frequency identification (RFID) sensors and one or more processors. The one or more processors are configured to control the one or more RFID sensors to emit one or more electromagnetic interrogation pulses, the one or more RFID sensors being installed on or around a building. The one or more processors are further configured to receive, via the one or more RFID sensors, a data tag including an identification number from an RFID tag attached to a firearm. The one or more processors are also configured to determine, based at least in part on the identification number, to perform a responsive action on the building. The one or more processors are further configured to, in response to determining to perform responsive action on the building, control one or more of one or more reactive devices to perform the responsive action on the building.

In another example, the disclosure is directed to a non-transitory computer-readable storage medium including instructions that, when executed, cause one or more processors to control one or more radio-frequency identification (RFID) sensors to emit one or more electromagnetic interrogation pulses, the one or more RFID sensors being installed on or around a building. The instructions, when executed, further cause the one or more processors to receive, via the one or more RFID sensors, a data tag including an identification number from an RFID tag attached to a firearm. The instructions, when executed, also cause the one or more processors to determine, based at least in part on the identification number, to perform a responsive action on the building. The instructions, when executed, further cause the one or more processors to, in response to determining to perform responsive action on the building, control one or more of one or more reactive devices to perform the responsive action on the building.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating an environment that includes a building with RFID sensors and a computer system to perform the techniques described herein.

FIG. 2 is a block diagram illustrating a more detailed example of a computing device configured to perform the techniques described herein.

FIG. 3 is an example RFID tag, in accordance with the techniques described herein.

FIG. 4 is an example RFID tag installed on a firearm, in accordance with the techniques described herein.

FIG. 5 is a flow chart illustrating an example method for performing the checks and responsive actions, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

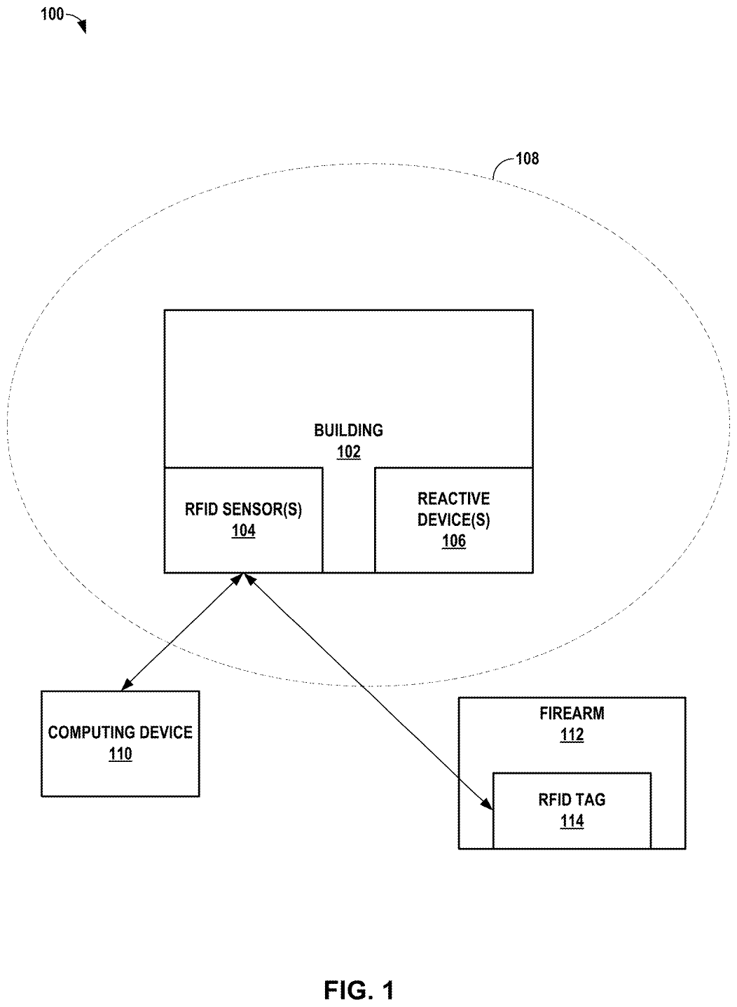

FIG. 1 is a block diagram illustrating an environment 100 that includes a building 102 with RFID sensors 104 and computing device 110 to perform the techniques described herein. Environment 100 may include building 102. Building 102 may be any private (e.g., a place of business, a home, etc.) or public (e.g., school building, college building, government building, etc.) structure. Although the techniques described herein are typically described with respect to physical structures, the techniques described herein could also apply to more mobile pieces of property (e.g., vehicles, gun safes, etc.).

Building 102 may include one or more RFID sensors 104. RFID sensors 104 may be installed inside building 102, on an exterior of building 102, or somewhere on the property grounds of building 102 (e.g., on a pole outside of building 102). RFID sensors 104 may be active or passive RFID readers capable of communicating with RFID tags, such as RFID tag 114. RFID sensors 104 may be configured with a varying range 108 such that RFID sensors 104 are able to read any RFID tag, such as RFID tag 114, that comes within range 108 of RFID sensors 104.

Building 102 may also include one or more reactive devices 106. Reactive devices 106 may be installed inside building 102, on an exterior of building 102, or somewhere on the property grounds of building 102 (e.g., on a pole outside of building 102). Reactive devices 106 may each be capable of executing some responsive action when controlled by computing device 110. For instance, reactive devices 106 may be lock systems to lock interior or exterior doors or windows, lights that flash or change colors, speakers to output an audible alarm or siren, communication devices to contact emergency services, or any other type of device described throughout this disclosure.

Computing device 110 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

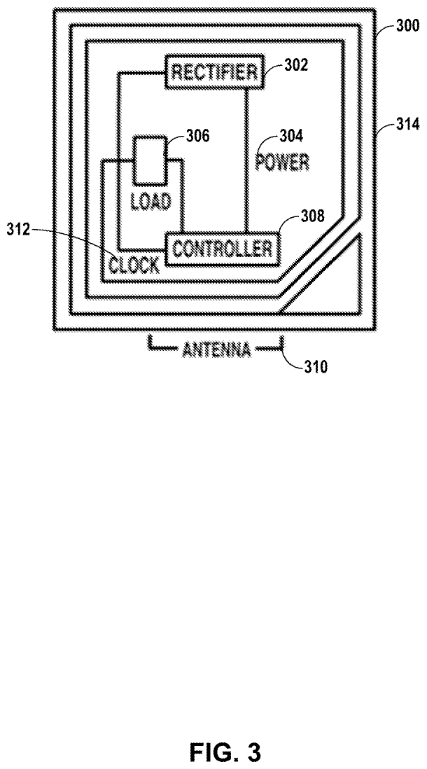

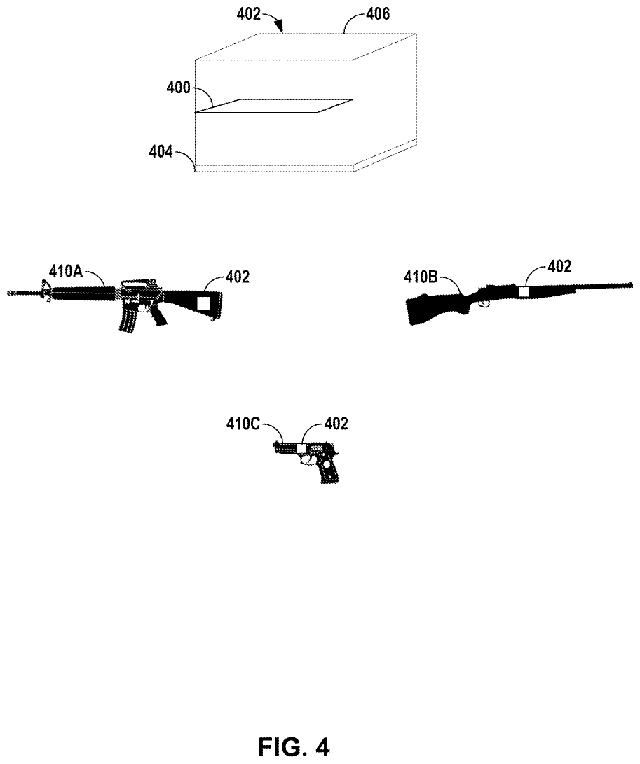

In some instances, a firearm 112 with attached RFID tag 114 may enter environment 100. A more detailed description of firearm 112 and RFID tag 114 is described with respect to FIGS. 3 and 4 below.

In accordance with the techniques described herein, computing device 110 may control RFID sensors 104 to emit one or more electromagnetic interrogation pulses, RFID sensors 104 being installed on (e.g., on an exterior or on an interior of building 102) or around building 102. When firearm 112 and RFID tag 114 come within range 108 of RFID sensors 104, computing device 110 may receive, via RFID sensors 104, a data tag including an identification number from RFID tag 114 attached to firearm 112. Computing device 110 may determine, based at least in part on the identification number, to perform a responsive action on building 102. In response to determining to perform responsive action on building 102, computing device 110 may control reactive devices 106 to perform the responsive action on building 102.

The goal of the system described herein is to include an RFID tag attached to a gun, which activates an RFID scanner at an assigned location. The tag can be detected at an adjustable distance from the scanner, triggering a response system.

When the RFID tag enters the scanner's range, the scanner creates a pilot communication to the tag in which the tag sends an identifier to the scanner to initiate inductive coupling. A system known as an enterprise subsystem (e.g., computing device 110) connects to the reader to verify the identifier with a database to ensure the detected tag is not unwanted. This provides a layer of authentication, making it secure.

The RFID scanner may have directional scanning and an adjustable scanning radius to fit the entrance and beyond in only the grounds or premise of the building.

In some instances, the system may include a “whitelist”, or a list of approved user identifications (UIDs) that will not trigger an emergency response. Whitelisted device examples could include police firearms (in case of stolen weapon so some response can still happen). In some instances, part of the responsive actions could still occur, such as a UID on the whitelist may notify administration or a front office but not trigger a full lockdown.

The scanner may be paired with an adjacent camera that will transfer a visual image to the front office of the school if the scanner gets a positive.

The scanner may be paired with some form of warning light to notify the school or intimidate the intruder.

The system may perform a number of responsive actions when the RFID scanner reads an RFID tag. Those responsive actions include: initiate a lockdown, locking the doors that are in the scanners range, but opening other doors that are not in the shooter range, if needed, locking all school doors, notifying the secretary/front desk, notifying the principal, notify the security guards/in school police officers, send message in school based CRISIS go app, communicating with the building loudspeakers, playing a siren over the speakers, flashing lights (like the smoke detectors, in order to support deaf individuals), controlling the color of the lights, play a siren on the outside of the school, shine a spotlight on the range the scanner covers, turn security cameras towards the scanner range, communication with all cell phones in the building/area, notify outside source, instant call to 911, send notification to police chief/officer, send message through an immediate response system to police, connect phone lines from police to school immediately, send message to emergency response groups through CRISIS go app (mobile alert system), connect walkie talkies from in-school police/school staff to police, front desk alert, building lockdown, in place active shooter protocol, first responder alarm, and mobile alert system.

This system could be installed in a number of places, including arcas seeking to detect and or control the traffic of guns through their premises. Some possible spaces include, but are not limited to, public facilities, schools/colleges/universities, government buildings, banks, malls, stadiums, gas stations, offices, restaurants, private locations, homes, and vehicles. The system could also have a number of potential commercial applications. One such application is to place an RFID scanner on a private gun safe. Removing a gun from the safe could notify the owner of the gun. Scanners could also be placed in cars providing transportation services (Uber, Lyft, etc.)

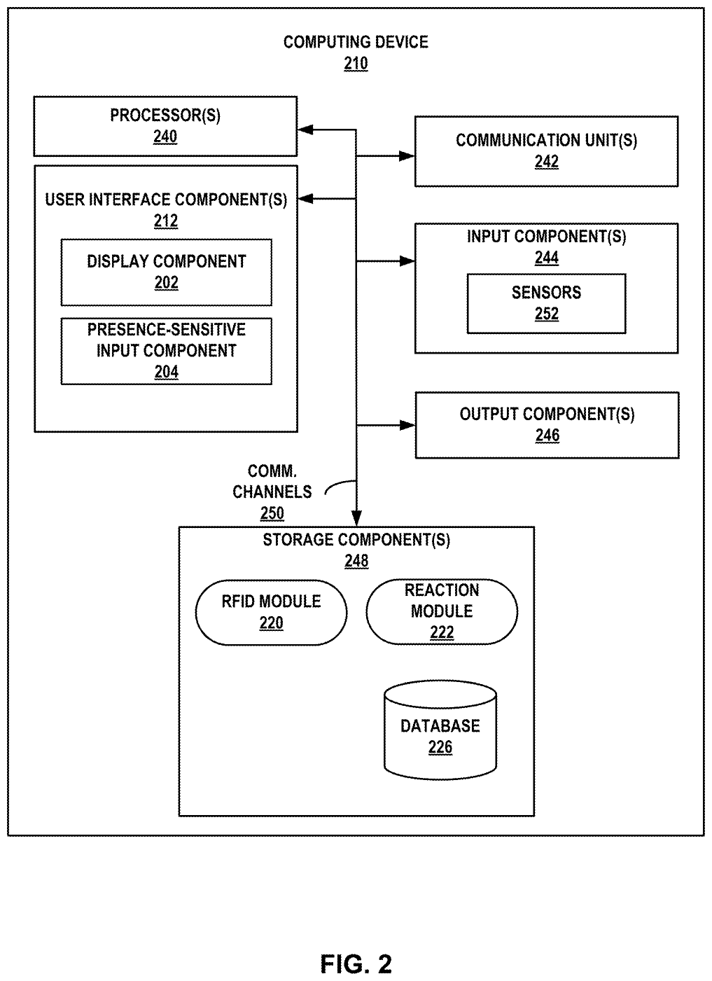

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include RFID module 220, reaction module 222, and database 226.

One or more processors 240 may implement functionality and/or execute instructions associated with computing device 210 to control RFID sensors and reactive devices on or near a building. That is, processors 240 may implement functionality and/or execute instructions associated with computing device 210 to implement responsive actions on a building when an RFID tag is detected.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 control RFID sensors and reactive devices on or near a building.

RFID module 220 may execute locally (e.g., at processors 240) to provide functions associated with controlling RFID sensors and communicating with RFID sensors. In some examples, RFID module 220 may act as an interface to a remote service accessible to computing device 210. For example, RFID module 220 may be an interface or application programming interface (API) to a remote server that communicates with and controls RFID sensors.

In some examples, reaction module 222 may execute locally (e.g., at processors 240) to provide functions associated with controlling reactive devices. In some examples, reaction module 222 may act as an interface to a remote service accessible to computing device 210. For example, reaction module 222 may be an interface or application programming interface (API) to a remote server that determines the proper responsive actions to trigger and control reactive devices to perform those responsive actions.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and database 226. Storage components 248 may include a memory configured to store data or other information associated with modules 220 and 222 and database 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, RFID module 220 may control one or more radio-frequency identification (RFID) sensors (e.g., RFID sensors 104 of FIG. 1) to emit one or more electromagnetic interrogation pulses. In some instances, the one or more RFID sensors may be one or more active RFID readers or scanners. The one or more RFID sensors being installed on or around a building (e.g., building 102 of FIG. 1). In some instances, the building may be any one or more of a public facility, a school building, a college building, a university building, a government building, a bank building, a mall building, a stadium, a gas station, an office building, a restaurant building, an arena, a theater, a home, a vehicle, and a commercial park, among other things.

RFID module 220 may receive, via the one or more RFID sensors, a data tag including an identification number from an RFID tag (e.g., RFID tag 114 of FIG. 1) attached to a firearm (e.g., firearm 112 of FIG. 1). In some instances, the identification number does not include any personally identifiable information. In some examples, the RFID tag may be an RFID transponder encased in a polymer resin with an adhesive backing to attach to the firearm.

Reaction module 222 may determine, based at least in part on the identification number, to perform a responsive action on the building. In response to determining to perform responsive action on the building, reaction module 222 may control one or more of one or more reactive devices (e.g., reactive devices 106 of FIG. 1) to perform the responsive action on the building. As the responsive actions are performed on the building rather than the firearm itself, in some instances, the responsive action does not alter any functionality of the firearm. Examples of a responsive action include any one or more of initiating an active shooter lockdown, locking one or more doors of the building that are in range of the RFID sensor and unlocking one or more other doors of the building that are not in the range of the RFID sensor, locking all doors of the building, notifying an administrator of the building, notifying one or more security guards in the building, sending message in a building-wide mobile device application, communicating with one or more speakers installed in or on the building, playing a siren over the one or more speakers, flashing one or more lights installed in or on the building, flashing one or more lights incorporated into one or more smoke detectors installed in or on the building, controlling a color of the one or more lights installed in or on the building, shine a spotlight on a range covered by the RFID sensor, activating one or more security cameras towards the range covered by the RFID sensor, sending a communication to all mobile telephones in an area of the building, sending a notification to a source outside of the building, sending an automated call to an emergency operator, sending a notification to a police officer, sending a message through an immediate police response system, connecting one or more phone lines from the building to the police officer, and connecting one or more radios at the building to the police officer.

For example, in some instances, one or more of the reactive devices may be one or more alarm devices. In such instances, reaction module 222 may control one or more of the one or more alarm devices to output an alarm notification. The alarm notification may be one or more of an audible alarm or a visual alarm. The one or more alarm devices may include any one or more of a mobile device, a computing device of an emergency service, a speaker system installed throughout the building and/or on an exterior of the building, a lighting system installed throughout the building and/or on the exterior of the building, and a computer system present inside of the building.

In some instances, one or more of the one or more reactive devices may include one or more lock systems. In such instances, the responsive action may include reaction module 222 controlling one or more of the one or more lock systems to activate the lock system into a locked state. Each of the one or more lock systems may be installed on one or more of an entrance into the building, an exterior window of the building, an interior door of the building, and an interior window of the building.

In some instances, the responsive action may include reaction module controlling one or more of the one or more reactive devices to seal one or more entrances into the building, such as by barring windows or releasing a garage-style retractable door over a door entrance.

In some instances, the one or more reactive devices may be one or more cameras. In such instances, the responsive action may include reaction module 222 controlling one or more of the one or more cameras to activate.

In some instances, the system may recognize firearms marked as safe, or accepted. For example, the data tag may be a first data tag, the RFID tag may be a first RFID tag, the firearm may be a first firearm, and the identification number may be a first identification number. Reaction module 222 may then register a second identification number in a whitelist database 226, or an accepted device database. In such instances, RFID module 220 may receive, via the one or more RFID sensors, a second data tag including the second identification number from a second RFID tag attached to a second firearm. Reaction module 222 may check database 226 for an inclusion of the second identification number. In some such instances, reaction module 222 may determine, based at least in part on the presence of the second identification number in the whitelist database, to not perform the responsive action on the building, thereby refraining from controlling the one or more reactive devices to perform the responsive action on the building. In other instances, reaction module 222 may perform only a portion of the responsive action rather than the full responsive action (e.g., only notify a principal, but do not lock the doors).

In furtherance of some such instances, reaction module 222 may determine to perform the responsive actions by first checking the whitelist database for an inclusion of the first identification number. Reaction module 222 may then determine to perform the responsive action on the building in response to determining that the first identification number is not present in the whitelist database.

In some instances, there may also be a restricted database. In such instances, reaction module 222 may check the restricted database for an inclusion of the first identification number. Reaction module 222 may determine to perform the responsive action on the building in response to determining that the first identification number is present in the restricted database.

In some instances, the building may be broken down into a plurality of zones. For instance, the one or more RFID sensors comprise a plurality of RFID sensors. A first RFID sensor of the plurality of RFID sensors may be installed within a first zone of the building, and a second RFID sensor of the plurality of RFID sensors may be installed within a second zone of the building, the second zone of the building being different than the first zone of the building. Similarly, the one or more reactive devices may include a first set of reactive devices located in the first zone and a second set of reactive devices located in the second zone of the building. When receiving the data tag, RFID module 220 may receive, via the first RFID sensor, the data tag. RFID module 220 may also fail to receive the data tag from the second RFID sensor, indicating that the firearm is only located close to the first zone but out of range of the second zone. In some such instances, when controlling the one or more reactive devices to perform the responsive action on the building, reaction module 222 may control one or more of the first set of reactive devices located in the first zone to perform the responsive action on the first zone of the building and refrain from controlling one or more of the second set of reactive devices located in the second zone to perform the responsive action on the second zone of the building. In other such instances, when controlling the one or more reactive devices to perform the responsive action on the building, reaction module 222 may control one or more of the first set of reactive devices located in the first zone to perform the first responsive action and the second responsive action on the first zone of the building, control one or more of the second set of reactive devices located in the first zone to perform the first responsive action on the second zone of the building, and refrain from controlling one or more of the second set of reactive devices located in the second zone to perform the second responsive action on the second zone of the building.

For example, the first responsive action may be outputting an alarm notification, and the second responsive action may be activating a lock system. It may be preferred to output the alarm to the entire building to make them aware of the potential active shooter, but to leave exits unlocked in the second zone far from the firearm location to allow people to escape.

FIG. 3 is an example RFID tag 300, in accordance with the techniques described herein. The RFID tag 300, in some instances, may be defined as a polymer resin encasing an RFID antenna 310 and an adhesive backing 314. The adhesive surface 314 enables permanent or semi-permanent bonding of the tag to a surface of a gun. The RFID antenna 310 may be, but not limited to, UHF (ultra-high frequency), and may use an active or a passive antenna. The RFID tag 300 may be composed of a silicon and copper. The RFID tag 300 may be also made up of the antenna, as the internal components (e.g., rectifier 302, power source 304, load 306, controller 308, and clock 312, among other potential parts) may be compact.

FIG. 3 is only one example of a potential RFID tag 300, and other RFID tags with other combinations of components may be usable for the techniques of this disclosure. For instance, RFID tag 300 may instead use an external power source, or may include an internal memory. For the purposes of this disclosure, any RFID tag capable of transmitting the data tags inclusive of the expected information to an RFID sensor of a building (e.g., RFID sensor 104 of FIG. 1) may be suitable for the performance of the described techniques.

FIG. 4 includes multiple examples of RFID system 402 installed on a variety of firearms 410A-410C, in accordance with the techniques described herein. RFID system 402 may include RFID tag 400 (which may be similar to RFID tag 114 of FIG. 1 or RFID tag 300 of FIG. 3), resin coating 406, and adhesive 404. As shown in FIG. 4, a common location for installing the RFID system 402 on a firearm using adhesive 404 may be on a stock of the firearm (e.g., firearm 410A), a pump of the firearm (e.g., firearm 410B), or a lower receiver of the firearm (e.g., firearm 410C), although any location safely away from the drastic temperature changes of the barrel of the firearm may be suitable for the purposes of this disclosure. A black (or color-matching the gun's color for camouflage purposes) RFID tag 400 covered in resin 406 may be embedded with a permanent adhesive element 404 in any of the described locations, such as 1-10 mm above the bottom of the handle, on a stock of the firearm, or on a pump of the firearm. The adhesive 404 may be strong to bond to the different gun components and minimize the risk of tampering and/or removing the tag system 402. The resin casing 406 can provide environmental protecting to the RFID components. The resin casing 406 may protect the RFID tag 400 from contacting metal that can cause an eddy current.

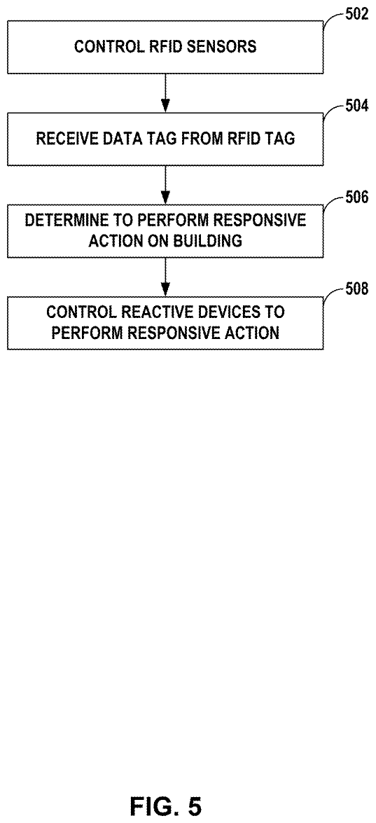

FIG. 5 is a flow chart illustrating an example mode of operation. The techniques of FIG. 5 may be performed by one or more processors of a computing device, such as system 100 of FIG. 1 and/or computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with the techniques described herein, RFID module 220 may control one or more radio-frequency identification (RFID) sensors 104 to emit one or more electromagnetic interrogation pulses, the one or more RFID sensors being installed on or around a building 102 (502). RFID module 220 may receive, via the one or more RFID sensors 104, a data tag including an identification number from an RFID tag 114 attached to a firearm 112 (504). Reaction module 222 may determine, based at least in part on the identification number, to perform a responsive action on the building 102 (506). In response to determining to perform responsive action on the building, reaction module 222 may control one or more of one or more reactive devices 106 to perform the responsive action on the building 102 (508).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
controlling, by one or more processors, one or more radio-frequency identification (RFID) sensors to emit one or more electromagnetic interrogation pulses, the one or more RFID sensors being installed on or around a building;
receiving, by the one or more processors via the one or more RFID sensors, a data tag including an identification number from an RFID tag attached to a firearm;
determining, by the one or more processors and based at least in part on the identification number, to perform a responsive action on the building; and
in response to determining to perform responsive action on the building, controlling, by the one or more processors, one or more of one or more reactive devices to perform the responsive action on the building.

2. The method of claim 1, wherein the one or more RFID sensors comprise one or more active RFID readers.

3. The method of claim 1, wherein one or more of the one or more reactive devices comprise one or more alarm devices, and wherein the responsive action comprises controlling, by the one or more processors, one or more of the one or more alarm devices to output an alarm notification,
wherein the alarm notification is one or more of an audible alarm or a visual alarm, and
wherein the one or more alarm devices comprise one or more of:
a mobile device;
a computing device of an emergency service;
a speaker system installed throughout the building and/or on an exterior of the building;
a lighting system installed throughout the building and/or on the exterior of the building; and
a computer system present inside of the building.

4. The method of claim 1, wherein the responsive action comprises one or more of:
initiating an active shooter lockdown;
locking one or more doors of the building that are in range of the RFID sensor and unlocking one or more other doors of the building that are not in the range of the RFID sensor;
locking all doors of the building;
notifying an administrator of the building;
notifying one or more security guards in the building;
sending message in a building-wide mobile device application;
communicating with one or more speakers installed in or on the building;
playing a siren over the one or more speakers;
flashing one or more lights installed in or on the building;
flashing one or more lights incorporated into one or more smoke detectors installed in or on the building;
controlling a color of the one or more lights installed in or on the building;
shine a spotlight on a range covered by the RFID sensor;
activating one or more security cameras towards the range covered by the RFID sensor;
sending a communication to all mobile telephones in an area of the building;
sending a notification to a source outside of the building;
sending an automated call to an emergency operator;
sending a notification to a police officer;
sending a message through an immediate police response system;
connecting one or more phone lines from the building to the police officer; and
connecting one or more radios at the building to the police officer.

5. The method of claim 1, wherein the building comprises one or more of:
a public facility;
a school building;
a college building;
a university building;
a government building;
a bank building;
a mall building;
a stadium;
a gas station;
an office building;
a restaurant building;
an arena;
a theater;
a home;
a vehicle; and
a commercial park.

6. The method of claim 1, wherein one or more of the one or more reactive devices comprise one or more lock systems, and wherein the responsive action comprises controlling, by the one or more processors, one or more of the one or more lock systems to activate the lock system into a locked state,
wherein each of the one or more lock systems are installed on one or more of:
an entrance into the building;
an exterior window of the building;
an interior door of the building; and
an interior window of the building.

7. The method of claim 1, wherein the RFID tag comprises an RFID transponder encased in a polymer resin with an adhesive backing to attach to the firearm.

8. The method of claim 1, wherein the responsive action comprises controlling, by the one or more processors, one or more of the one or more reactive devices to seal one or more entrances into the building.

9. The method of claim 1, wherein the data tag comprises a first data tag, wherein the RFID tag comprises a first RFID tag, wherein the firearm comprises a first firearm, wherein the identification number comprises a first identification number, and wherein the method further comprises:
registering, by the one or more processors, a second identification number in a whitelist database;
receiving, by the one or more processors via the one or more RFID sensors, a second data tag including the second identification number from a second RFID tag attached to a second firearm;
checking, by the one or more processors, the whitelist database for an inclusion of the second identification number;
determining, by the one or more processors and based at least in part on the presence of the second identification number in the whitelist database, to not perform the responsive action on the building; and
refraining, by the one or more processors, from controlling the one or more reactive devices to perform the responsive action on the building.

10. The method of claim 9, further comprising:
checking, by the one or more processors, the whitelist database for an inclusion of the first identification number; and
determining, by the one or more processors, to perform the responsive action on the building in response to determining that the first identification number is not present in the whitelist database.

11. The method of claim 1, wherein one or more of the one or more reactive devices comprise one or more cameras, and wherein the responsive action comprises controlling, by the one or more processors, one or more of the one or more cameras to activate.

12. The method of claim 1, further comprising:
checking, by the one or more processors, a restricted database for an inclusion of the first identification number; and
determining, by the one or more processors, to perform the responsive action on the building in response to determining that the first identification number is present in the restricted database.

13. The method of claim 1, wherein the identification number does not include any personally identifiable information.

14. The method of claim 1, wherein the responsive action does not alter any functionality of the firearm.

15. The method of claim 1, wherein the one or more RFID sensors comprise a plurality of RFID sensors, wherein a first RFID sensor of the plurality of RFID sensors is installed within a first zone of the building, wherein a second RFID sensor of the plurality of RFID sensors is installed within a second zone of the building, the second zone of the building being different than the first zone of the building, wherein the one or more reactive devices include a first set of reactive devices located in the first zone and a second set of reactive devices located in the second zone of the building.

16. The method of claim 15,
wherein receiving the data tag comprises:
receiving, by the one or more processors and via the first RFID sensor, the data tag; and
failing, by the one or more processors, to receive the data tag from the second RFID sensor; and
wherein controlling the one or more reactive devices to perform the responsive action on the building comprises:
controlling, by the one or more processors, one or more of the first set of reactive devices located in the first zone to perform the responsive action on the first zone of the building; and
refraining, by the one or more processors, from controlling one or more of the second set of reactive devices located in the second zone to perform the responsive action on the second zone of the building.

17. The method of claim 15, wherein the responsive action comprises a first responsive action and a second responsive action;
wherein receiving the data tag comprises:
receiving, by the one or more processors and via the first RFID sensor, the data tag; and
failing, by the one or more processors, to receive the data tag from the second RFID sensor; and
wherein controlling the one or more reactive devices to perform the responsive action on the building comprises:
controlling, by the one or more processors, one or more of the first set of reactive devices located in the first zone to perform the first responsive action and the second responsive action on the first zone of the building;
controlling, by the one or more processors, one or more of the second set of reactive devices located in the first zone to perform the first responsive action on the second zone of the building; and
refraining, by the one or more processors, from controlling one or more of the second set of reactive devices located in the second zone to perform the second responsive action on the second zone of the building.

18. The method of claim 17, wherein the first responsive action comprises outputting an alarm notification, and wherein the second responsive action comprises activating a lock system.

19. A system comprising:
one or more radio-frequency identification (RFID) sensors; and
one or more processors configured to:
control the one or more RFID sensors to emit one or more electromagnetic interrogation pulses, the one or more RFID sensors being installed on or around a building;
receive, via the one or more RFID sensors, a data tag including an identification number from an RFID tag attached to a firearm;
determine, based at least in part on the identification number, to perform a responsive action on the building; and
in response to determining to perform responsive action on the building, control one or more of one or more reactive devices to perform the responsive action on the building.

20. A non-transitory computer-readable storage medium comprising instructions that, when executed, cause one or more processors to:
control one or more radio-frequency identification (RFID) sensors to emit one or more electromagnetic interrogation pulses, the one or more RFID sensors being installed on or around a building;
receive, via the one or more RFID sensors, a data tag including an identification number from an RFID tag attached to a firearm;
determine, based at least in part on the identification number, to perform a responsive action on the building; and
in response to determining to perform responsive action on the building, control one or more of one or more reactive devices to perform the responsive action on the building.
